(19) United States
(12) Patent Application Publication
(10) Pub. No.: US 2009/0086571 A1
(43) Pub. Date: Apr. 2, 2009

(54) Apparatus for the production of a reactive flowable mixture

(76) Inventors: Joachim Studlek, Asslar (DE); Stefan Lutiger, Seuzach (CH); Alexander Wanzki, Uberlingen (DE); Sasan Habibi-Naini, Rikon (CH)

Correspondence Address: Francis C. Hand, Esq.,;c/o Carella, Byrne, Bain, Gilfillan.Cecchi, Stewart & Olstein, 5 Becker Farm Road, Roseland, NJ, 07068, US

(21) Appl. No.: 12/284,628

(22) Filed: Sep. 24, 2008

(30) Foreign Application Priority Data
Sep. 27, 2007 (EP) 07117425.4

(51) Int. Cl. B01F 15/02; B01F 15/04; B01F 15/06

(52) U.S. Cl. 366/144; 366/154.1; 366/158.5

(57) ABSTRACT

An apparatus for the production of a reactive flowable mixture includes a mixing block which includes at least one first passage for at least one first component of the mixture, a second passage for another component of the mixture and a collection passage for the mixture. At least one static mixing element is located in the collection passage where the second passage opens into the collection passage to receive the second component therein.

This invention relates to an apparatus for the production of a reactive flowable mixture.

As is known, EP-A-1 600 470 describes an apparatus for the production of a reactive flowable mixture particularly useful in the processing of silicon rubber (or LSR—“liquid silicon rubber”). In the described process, silicon rubber is supplied in two components. The two components are not reactive separately and can be stored at room temperature. Only by the mixture of the components in a mixing stage does a reactive mixture arise whose reaction time depends on the composition of the mixture as well as on additives, such as catalysts and inhibitors, and which is adjustable in wide ranges.

A processing apparatus in which the reaction should then take place follows the mixing stage. A molded part is produced in a continuous or discontinuous process in the processing apparatus. For example, an extrusion process may be used for a continuous process and a pressure molding or injection molding process may be used for a discontinuous process.

The residence time of the mixture in the molds is the greater, the lower the reaction speed is. The residence time corresponds to at least the time period up to the reaching of a conversion of 90%, called a reaction time in the following.

In order to increase the productivity of a plant for the processing of silicon rubber, this residence time, and therefore also the reaction time, should be kept as low as possible. A shortening of the reaction time can be achieved either by increasing the reaction temperatures or by using components of greater reactivity, wherein the reaction may not start before the mixture has reached the processing apparatus. However, construction constraints previously stood in the way of this objective which made a long path of the mixed components up to the processing apparatus necessary. Moreover, in a previously known mixing apparatus, dead zones occur in the passages through which the mixture flows and in which at least some of the mixture remains in the dead zones for so long that the chemical reaction already starts. If a solidification of the individual components occurs due to the chemical reaction, the mixing apparatus clogs or parts of the already reacted mixture move into the following plant for the processing of the mixture. So-called incipiently cross-linked material can move into the product, whereby the quality can be impaired. The consequences range from production downtimes, the production of rejects, time consuming and/or expensive cleaning processes, up to replacement of damaged machine parts.

Accordingly, it is an object of the invention to avoid a long path and dead zones in the production of a reactive flowable mixture.

It is another object of the invention to increase the operational security of a process for the production of a reactive flowable mixture.

It is another object of the invention to avoid a premature reaction of the reactive components of a reactive flowable mixture prior to the entry of the mixture into a downstream processing apparatus such as the cavity of an injection molding tool.

It is another object of the invention to increase productivity of a reactive flowable mixture by using mixtures, which react faster.

It is another object of the invention to be able to disassemble and clean a mixing device used in a process for the production of a reactive flowable mixture after use in as few steps as possible.

It is another object of the invention to be able to transform a mixing device used in a process for the production of a reactive flowable mixture after use into an inoperative state suitable for storage.

Briefly, the invention provides an apparatus for the production of a reactive flowable mixture that comprises a mixing block having at least one first passage for receiving at least one component of a reactive mixture, at least one second passage for receiving a second component of the reactive mixture and a collection passage in communication with the first passage to receive the one component therefrom and the second passage to receive the second component therefrom.

In accordance with the invention, the apparatus includes at least one mixing means disposed in and extending along the collection passage that occupies a location within the collection passage wherein the second passage opens into the collection passage to receive the second component therein.

The leading together of the components and the subsequently directly occurring mixing of the components thus takes place in a single part of the apparatus, namely the mixing block, whereby the formation of dead zones is avoided.

The residence time of the mixture in the collection passage can therefore be precisely determined and is set such that it is less than the reaction time of the mixture. In this connection, the term “reaction time” includes the sequence described in the following which co-determines the residence time of the mixture.

The mixture can include components which inhibit a chemical reaction. These components are also called inhibitors. The chemical reaction is prevented or postponed in time by an inhibitor. The actual reaction of the components forming the mixture can only start when a large portion of the inhibitors have been depleted which takes place under the effect of temperature, for example. The speed at which this procedure runs is furthermore a function of the temperature, in particular of the tool temperature. This tool temperature lies in the range from 150-220° C. for liquid silicon rubber mixtures. The depletion of the inhibitors runs very slowly in this application in ranges which are substantially beneath this temperature range. If, therefore, at least two components which include an inhibitor are mixed at temperatures which are between 20 and 45° C., the two components do not behave substantially differently with respect to their processing capability after their mixing than before the mixing because the depletion of the inhibitors and the reaction of the components takes place much more slowly.

With very long residence times during ongoing production processes, a start of the reaction can nevertheless occur, not least due to dead zones caused by construction aspects. In this case, problems occur which were described in connection with the prior art. As soon as the components are mixed, the mixture is reactive, that is to say, the probability of a chemical reaction increases continuously with the time during which the components are mixed. A temperature increase reduces the time up to the start of the reaction so that it is to be expected at increased operating temperatures that the reaction takes place earlier than at temperatures between 20 and 45° C.

A further advantage of the avoidance of dead zones by using the mixing block in accordance with the invention can thus be found in the fact that the reactivity of the components can be directly increased. The cycle time, that is the time which passes from the provision of the mixture in a cavity of a molding tool up to the conclusion of the reaction in this cavity and the ejection of a molded part can thus be shortened. If the reactivity of the components is not changed with respect to the prior art or is only changed to a small degree, higher operational security can be achieved.

In a particularly advantageous embodiment of the apparatus in accordance with the invention, the collection passage has a substantially constant cross-sectional development so that the collection passage can be cleaned particularly easily and can be manufactured cost-effectively. In accordance with a particularly preferred embodiment, the passages have a circular cross-section, with the diameter of the collection passage preferably being smaller than or equal to the diameter of each of the component feed passages, i.e. not being larger than the diameter of the feed passages.

At least one of the first and second passages can have a constriction in accordance with a further embodiment. Such a constriction avoids a backflow of the components flowing through the first passage into the second passage which includes the inflowing component.

The mixing means contained in the collection passage is in particular designed as a static mixing element by means of which the individual components can be mixed fast and uniformly with one another. A static mixing element of the type according to Swiss Patent CH 642564 has proved to be particularly advantageous.

The mixing block includes a heat exchanging means for adjusting the temperature, in particular for the cooling of the collection passage, so that a premature reaction of the component of the mixture is suppressed.

A fastening apparatus is also provided for a supply means in the region of at least one of the first and second passages on a surface of the mixing block. The fastening apparatus includes two releasable hoop elements between which a flange of the supply means can be clamped. The hoop elements can be fastened on the surface of the mixing block by means of fastening means such that a fluid-tight connection can be produced between the supply means and the passage. The fastening means in particular include a pair of screws.

The flushing times for the apparatus are also substantially reduced by the reduction of the dead zones. After use or before a change to a mixture of a different composition, the passages have to be flushed with a component so that the other reactive component is reliably removed by the flushing. In this respect, it is considered unproblematic, if only a single component remains in the passages of the mixing block, in particular if this component is not itself reactive, that is to say it has an at least limited chemical stability and consequently storability. If the mixing block has to be stored, that is to say taken out of operation, it is sufficient to flush the passages of the mixing means. For this purpose, the infeed of a component is suppressed in that the supply means is removed from the mixing block. The inlet opening of the now open passage is then blocked by a plug and is flushed with the other component. The dimensions of the plug are preferably selected such that the plug fills up the inner passage space from the inlet opening up to the unification with the other passage so that the dead zones are minimized. Advantageously, the plug seals the passage, such that the component, which is used for flushing does not discharge into the environment. In case any residues of the second component remain in the passage, the passage can also be kept open for a time, so that the component used for flushing pushes any residues of the second component safely to the outside. Then the plug is reinserted and the passage kept closed until the mixing block is used again. Consequently, the flushing process can be carried out in an extremely time-saving manner due to the only low contamination. Thus, a substantial advantage arises in that only a little time is required to change to components of a different composition and to commence operation after a period of downtime.

The reduction of the flush times is particularly advantageous for the use of the apparatus for the mixing of dyes. The flush time can, on the one hand, be reduced by the large elimination of dead zones by means of the apparatus in accordance with the invention and, on the other hand, a fast change to a new system of infeeds can take place due to the reduction of the assembly times because a much smaller number of assembly steps is required for the replacement of a complete hose system when using the fastening apparatus. It is sufficient to release the plug and to attach the supply means for the second component to the mixing block by means of the fastening means described hereafter.

A preferred use of the apparatus is the manufacture of a molded part. Such a molded part can be obtained in an injection moulding process, but also as a semi-finished product, for example as a strand in a continuous process, such as an extrusion process. The use of the apparatus in particular takes place in a plant for the processing of silicon rubber. The apparatus in accordance with one of the preceding embodiments can generally serve for the processing of a mixture.

These and other objects and advantages of the invention will become more apparent from the following detailed description taken in conjunction with the accompanying drawings wherein:

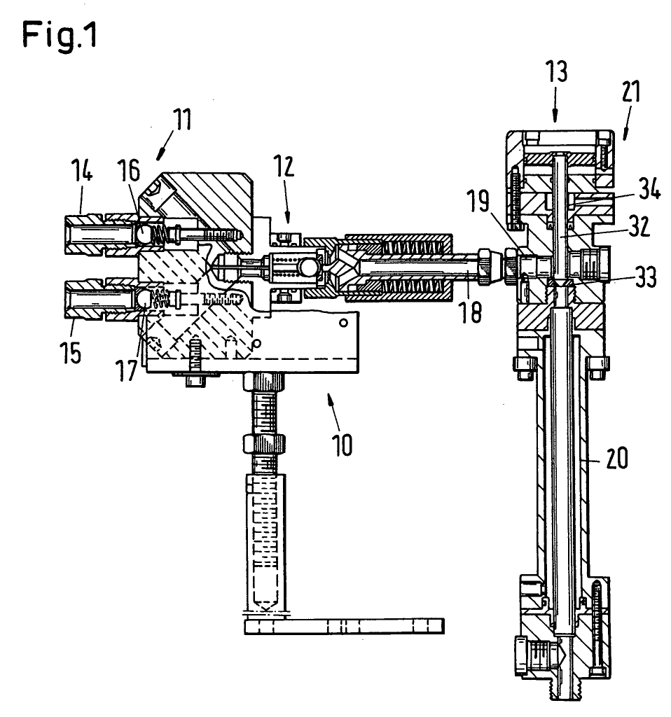

FIG. 1 illustrates a part cross-sectional view of an apparatus in accordance with the prior art;

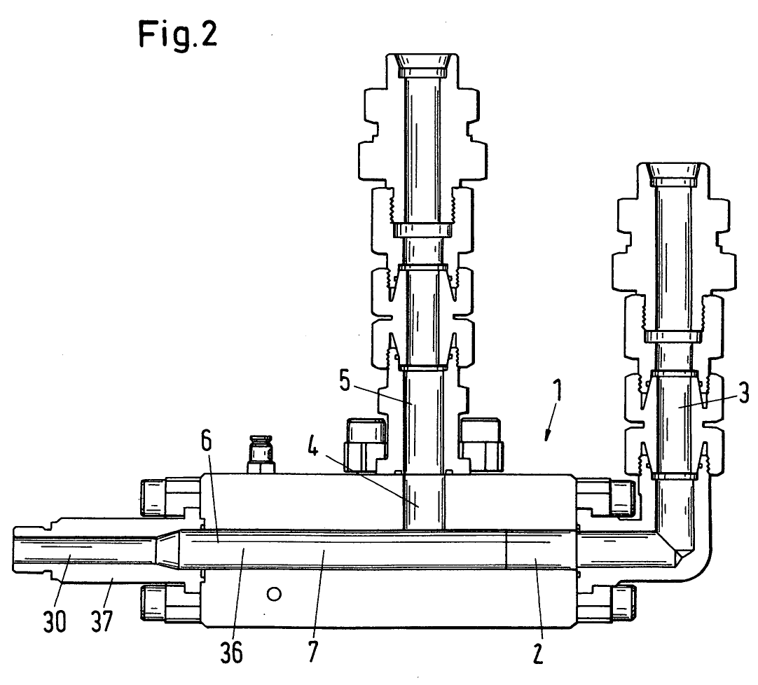

FIG. 2 illustrates a part cross-sectional view of a section of an apparatus for the production of a reactive flowable mixture that employs a mixing block in accordance with the invention:

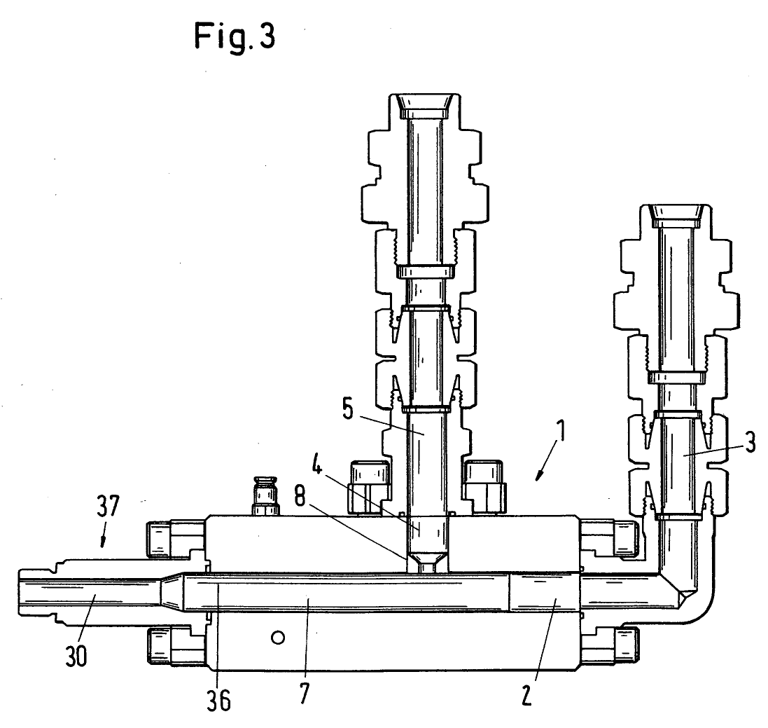

FIG. 3 illustrates a cross-sectional view similar to FIG. 2 of a modified mixing block in accordance with the invention;

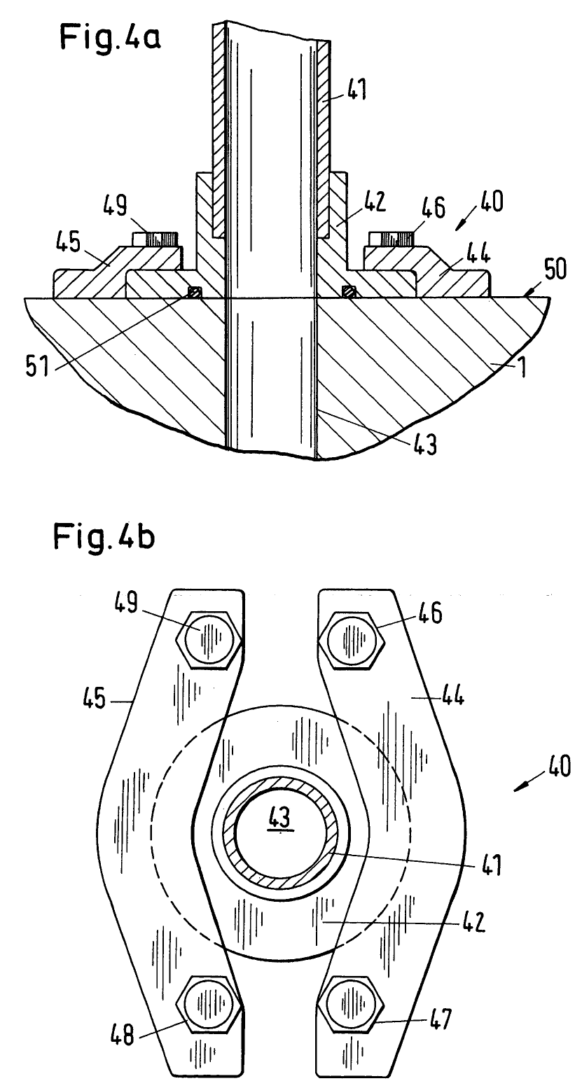

FIG. 4a illustrates a cross-sectional view of a connection between a supply means and a mixing block in accordance with the invention;

FIG. 4b illustrates a plan view of the connection of FIG. 4a;

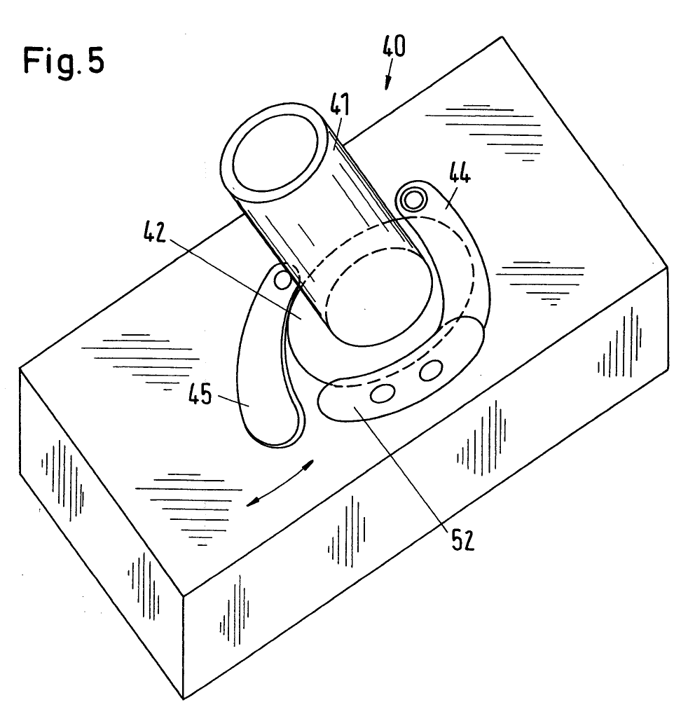

FIG. 5. illustrates a perspective view of a modified connection between a supply means and a mixing block in accordance with the invention;

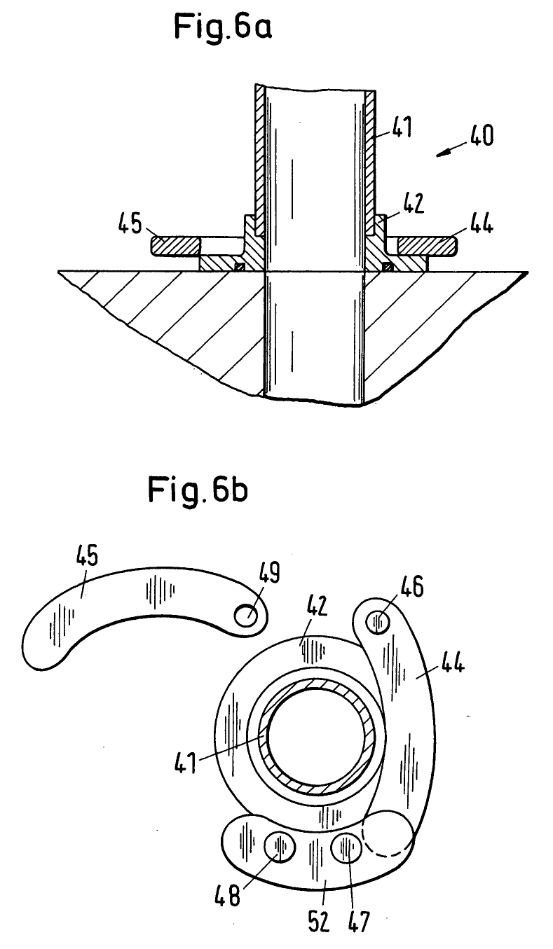

FIG. 6a illustrates a cross-sectional view of a further connection between a supply means and a mixing block in accordance with the invention;

FIG. 6b illustrates a plan view of the connection of FIG. 6a;

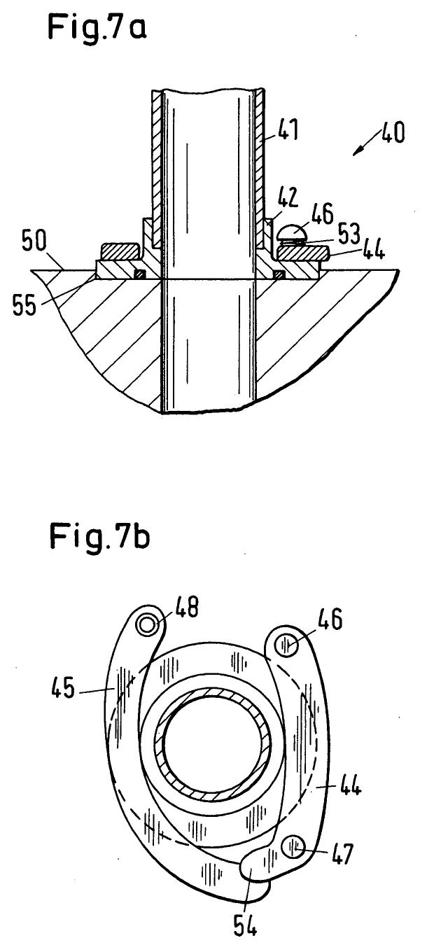

FIG. 7a illustrates a cross-sectional view of a further connection between a supply means and a mixing block in accordance with the invention;

FIG. 7b illustrates a plan view of the connection of FIG. 7a; and

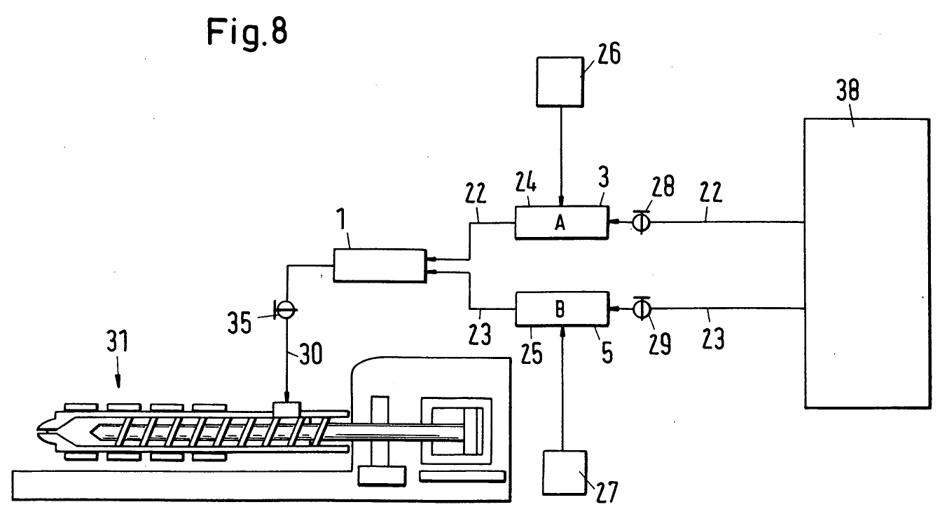

FIG. 8 illustrates a schematic view of a plant in which the apparatus in accordance with the invention is used.

Referring to FIG. 1, a known apparatus 10 for the conveying of a reactive flowable mixture includes a supply unit 11, a collection unit 12 and a mixing unit 13.

The supply unit 11 contains a first supply line 14 for a first component 3 and a second supply line 15 for a second component 5. The first supply line contains a first check valve 16 and the second supply line contains a second check valve 17.

The two components are guided together in the collection unit 12 downstream of the check valves 16, 17. The two components exit the collection unit 12 through the collection passage 18. The collection passage 18 contains the first and second components. If the components are high-viscosity fluids, hardly any mixing of the components takes place while they flow through the collection passage 18.

The collection passage 18 opens into the actual mixing unit 13 in which an inlet passage 19 is provided which opens into a mixing passage 20 arranged at an angle of 90°. The deflection of the inlet passage 19 into the mixing passage 20 is required for constructional reasons since a shut-off device 21 is provided which can prevent the throughflow of the two components. The shut-off device 21 is designed as a valve in FIG. 1 and includes a fluid-actuated needle 32 which lies on an associated seated element 33. The needle 32 is guided slidingly in a passage 34 whose diameter is smaller than the diameter of the inlet passage 19. The inner diameter of the seated element 33 is smaller than the diameter of the mixing passage downstream and upstream thereof. The forming of dead zones is therefore unavoidable in this region, which has the consequence that the components of the reactive mixture start to react with one another on a sufficient residence time in the dead zone.

Referring to FIG. 2, the apparatus in accordance with the invention is used for the conveying of a reactive flowable mixture 6 and includes a mixing block 1 which has at least one first passage 2 for a first component 3 of the mixture and a second passage 4 for a second component 5 of the mixture. The mixing block furthermore includes a collection passage 7 for the mixture 6 into which the first passage 2 and the second passage 4 open. The residence time of the mixture in the collection passage 7 is less than the reaction time of the components of the mixture in accordance with the statements at a prior position.

The collection passage 7 has a circular cross-section at least sectionally, in particular a circular cross-section with a constant diameter. A mixing means 36, in particular a static mixing element, can be attached in the collection passage 7. A particularly suitable static mixing element is disclosed, for example, in Swiss Patent CH 642564, the disclosure of which is incorporated herein. Such a mixing element is arranged in the collection passage 7 which forms a tubular housing for the mixing element. The static mixing element 36 consists of crossing bars which have an angle with respect to the axis of the collection passage. The bars of the mixing element are arranged in at least two groups. The bars within each group are directed substantially in parallel and the bars of the one group intersect with the bars of the other group. The ratio of the maximum bar width to the diameter of the collection passage particularly preferably amounts to 0.1 to 0.167; the ratio of the perpendicular spacing of the bars of a group to the diameter of the collection passage amounts in particular to 0.2 to 0.4 and the ratio of the length of the mixing element to the diameter of the collection passage amounts to 0.75 to 1.5. The bars have a flow-dividing effect so that a good mixing can already be achieved after a length of 4 to 12 diameters of the collection passage, that is after flowing through a plurality of such mixing elements. For the case that additional additives, such as dyestuffs, should be added, such a mixing element can compensate viscosity differences between the components and the additives due to its high mixing performance.

The collection passage 7 opens into a collection line 30 which leads to a processing apparatus (not shown). The collection line 30 is arranged in a transition element 37 that serves for the connection of the mixing block 1 to the processing apparatus which is designed, for example, as an extruder or as an injection molding machine. In the variant shown in FIG. 2, the transition element 37 is attached to the mixing block 1 by means of screw connections. The transition element 37 also has an external thread which enables a coupling to the processing apparatus.

The collection line 30 in the interior of the transition element includes a conical transition which serves for the reception of a first end of the mixing element 36. The mixing element 36 is thus positioned in the collection passage 7 and the collection line 30 by the conical transition and is fixed in a central position. At the same time, this variant presents the possibility of separating the transition element 37 from the mixing block 1 when loosening the screw connection and of removing the mixing element 36 to clean it or to prepare the mixing block 1 for another mixture. Alternatively to this, no mixing element can be provided or a mixing element of a different type can be used. The composition of the mixture to be processed and/or installations, such as mixing elements, can be changed simply and fast due to this modular construction.

A cleaning of the mixing element 36 can take place in the removed state without a production downtime of longer duration being necessary.

The mixing block can have a heat exchanging means, which is particularly advantageous when processing mixtures which tend to accelerated reaction and/or to accelerated reduction of inhibitors at higher temperatures. The heat exchanging means can in particular be designed as a cooling jacket or can have cooling passages (not shown) in the interior of the mixing block 1 through which a cooling medium, in particular a cooling fluid, circulates to cool the collection passage 7. The use of a liquid cooling medium has proven to be particularly advantageous. In particular oil or water are used as liquids.

Referring to FIG. 3, wherein like reference characters indicate like parts as above, at least one of the first and second passages 2, 4 has a constriction 8 to avoid that one component is pressed into the other. This problem primarily occurs when the throughgoing passage 2 includes a mixing means 36. This mixing means, in particular in the embodiment as a static mixing element, represents an obstacle for the passage flow of the first component 3 in passage 2. Some of the first component 3 flowing through the passage 2 can be deflected in the direction of the passage 4 so that this passage no longer only includes the second component 5, but also portions of the first component 3. Alternatively to this, this effect occurs when the pressure of the first component directly upstream of the opening of passage 4 is larger than the pressure in the passage 4.

The mixing block 1 and the mixing means 36 are parts of a modular system which is easy to assemble, to clean and to use. The bore diameter of the first and second passages 2, 4 and of the collection passage 7 can be easily adapted to the components used or to the mixture. On the one hand, the mixing block 1 itself can be replaced; on the other hand, the passages can be provided with inserts, for example in the form of sleeves, by means of which the effective diameter of the corresponding passage is reduced. To increase the assembly friendliness of the system, fastening apparatuses are preferably used for the infeeds of the components which will be described in more detail in the following.

Referring to FIGS. 4a and 4b, a fastening apparatus 40 for a supply means 41 is mounted on a surface of the mixing block 1 in the region of at least one of the first and second passages. The supply means 41 can be made as a hose which serves for the infeed of one of the components and which ends in a flange 42.

The fastening apparatus 40 for the supply means 41 is attached to the surface 50 of the mixing block 1 in the region of the inlet opening 43 of at least one of the passages. The fastening apparatus 40 includes two releasable hoop elements 44, 45 between which a part of the flange 42 of the supply means 41 can be clamped. The hoop elements 44, 45 can be fastened to the surface 50 of the mixing block 1 by means of fastening means 46, 47, 48, 49 such that a fluid-tight connection can be produced between the supply means 41 and the passage. The fastening means 46, 47, 48, 49 are designed in each case as a pair of screws in accordance with a preferred embodiment.

Advantageously, two hoop elements 44, 45 are arranged opposite one another and on opposite sides of the flange 42 so that a pressing of the flange 42 onto the surface 50 results which is the same on all sides. A seal 51 is arranged between the flange 42 and the surface 50 of the mixing block 1.

Referring to FIG. 5, wherein like reference characters indicate like parts as above, at least one hoop element 44, 45 of the fastening means 40 can be arranged in a pivotable manner on the mixing block 1. The pivotable hoop element 45 is then brought into a closed position after positioning the flange 42 of the supply means 41, whereby a pressure is exerted onto the flange 42 so that the flange remains blocked in the clamped position. For this purpose, the pivotable hoop element 45 is brought into engagement with a holding means 52.

Referring to FIGS. 6a and 6b, wherein like reference characters indicate like parts as above, positioning aid means (not shown) can be used for the positioning of the supply means 40. Alternatively to this, it is possible to bring about the final positioning of the supply means 40 by closing the pivotable hoop element 44. In this case, a contact advantageously takes place of the hoop element 44 and the flange 42, as shown in FIG. 6b. The two hoop elements 44 and 45 are pivotally supported on respective fastening means 46, 49, such as a cylindrical pin. The hoop element 44 has a bore through which the cylindrical pin is guided in the assembled state. The cylindrical pin has a head such that the hoop element 44 is held on the cylindrical pin with security against being lost.

The hoop element 44 is pushed under a holding means 52 shown in FIG. 6b to close the connection. The holding means 52 can have a slide track which is inclined at an angle relative to the cover surface of the holding means 52 so that the contact pressure onto the flange increases continuously. If the desired contact pressure has been reached, the hoop element 44 latches with the holding means 52.

For the adjustment of the contact pressure, the spacing of the holding means 52 and/or the spacing of the hoop element 44, 45 is variably adjustable in that, for example, at least one of the fastening means 47, 48 is designed as a screw. When screws are provided for the holding means 52, the holding means 52 can also be at least partly loosened or even completely removed if the connection should be opened for the removal of the supply means 41 together with its flange 42. In accordance with this embodiment, it is therefore not necessary to release a single screw completely. The supply means 41 can therefore, on the one hand, be replaced quickly and, on the other hand, no small parts can be lost on a replacement of the supply means on assembly or dismantling.

Referring to FIGS. 7a and 7b, wherein like reference characters indicate like parts as above, a third embodiment for a fastening apparatus 40 for a supply means 41 employs two hoop elements 44 and 45, wherein one hoop element 44 is able to remain in position during the dismantling of a supply means 41. The flange 42 is pushed underneath the hoop element 44. The hoop element 44 is held by two fastening means 46, 47. At least one of the fastening means can be designed as a cylindrical pin with a head. To produce a defined contact pressure, a spring element 53 can be arranged between the head of the cylindrical pin 46 and the hoop element 44, the spring element being pre-tensioned on the introduction of the flange 42. The hoop element 44 is pre-tensioned by the spring element 53 when the flange is located between the surface 50 of the mixing block 1 and the hoop element 44.

A second hoop element 45 is provided to ensure a contact pressure which is substantially equal over the periphery of the flange. The hoop element 45 is arranged pivotably around a fastening means 48. This hoop element 45 can be brought into engagement with a projection 54 of the other hoop element 44. The complete release of even just one single fastening means is also not necessary in accordance with this embodiment. For the positioning of the flange 42, a peripheral step 55, shown in FIG. 7a, can also be provided in the surface 50 or at the flange (not shown).

The fastening apparatuses shown in FIGS. 4 to 7 thus only require an extremely low number of assembly and dismantling steps.

Referring to FIG. 8, a plant that employs the above-described apparatus includes a metering device 38 for each of the components to be supplied, a first infeed 22 for a first component 3 and a second infeed 23 for a second component 5. The number of the components and/or infeeds can also be larger than two. The infeeds 22 and 23 open into a mixing block 1 as above described.

A first injection apparatus 24 can be provided in the first infeed 22 and an additive can be added to the component 2 by means of the infeed 22. Such an additive is, in particular, a foaming agent, such as carbon dioxide. The additive is supplied from an additive source 26, with such an additive source being designed as a pressure container, in particular as a compressed gas bottle, for gaseous additives.

A second injection apparatus 25 can also be provided in the second infeed 23 and is fed from a second additive source 27. A plurality of additive sources can naturally also be provided per injection apparatus or injection apparatuses can be connected directly to the mixing block.

The supply of the individual components can be suppressed by means of shut-off means 28, 29, with the shut-off means in particular being designed as passive check valves or as pressure-reducing valves.

The collection passage (not shown) in the interior of the mixing block 1 opens into a collection line 30 which leads to a processing apparatus 31 for the manufacture of articles from the mixture 6.

The processing apparatus 31 can in particular be made as an extruder or as an injection moulding machine.

The mixing block 1 is in particular used in a plant for the processing of silicon rubber or for the processing of at least one highly reactive component. Highly reactive is defined as follows for the use on silicon rubber: the reactivity of silicon rubber is usually characterised via the t₉₀ time. This t₉₀ time determines the time at a given temperature at which a reaction conversion of 90% has been reached. At 120° C., this value usually amounts to 50 to 60 seconds for silicon rubber. If, for example, the reaction conversion of 90% is already reached after 45 seconds, that is 10% faster, this material can already be called highly reactive. Highly reactive materials in the sense of the application are thus silicon rubbers whose reaction conversion in accordance with the t₉₀ time is achieved in a time duration shorter by at least 10%, preferably in a time duration shorter by 15%, particularly preferably in a time duration shorter by 20%.

If in particular foamable material should be processed using the mixing block 1, an actively actuated closing member 35 can be provided downstream of the mixing block 1 before the inlet into the processing device 31. The mixing block 1 is separated from the processing apparatus by means of this actively actuable closing member 35, which is in particular designed as a check valve, when foamable components should be processed with the mixing block.

The use of manometers or pressure transducers is possible to improve the process monitoring.

The invention thus avoids a long path and dead zones in the production of a reactive flowable mixture while increasing the operational security of the process.

The invention also avoids a premature reaction of the reactive components of a reactive flowable mixture prior to the entry of the mixture into a downstream processing apparatus such as the cavity of an injection molding tool.

The invention also allows an increase in productivity of a reactive flowable mixture by using mixtures which react faster.

Still further, the invention allows the mixing block to be disassembled and cleaned after use in as few steps as possible and allows the mixing block to transform after use into an inoperative state suitable for storage.

What is claimed is:

1. An apparatus for the production of a reactive flowable mixture comprising
a mixing block having at least one first passage for receiving at least one component of a reactive mixture, at least one second passage for receiving a second component of the reactive mixture and a collection passage in communication with said first passage to receive the one component therefrom and said second passage to receive the second component therefrom; and
at least one mixing means disposed in and extending along said collection passage, said mixing means occupying a location within said collection passage wherein said second passage opens into said collection passage to receive the second component therein.

2. An apparatus as set forth in claim 1 wherein said collection passage has a constant cross-section along the length thereof to avoid dead zones.

3. An apparatus as set forth in claim 1 wherein said collection passage has a circular cross-section along the length thereof.

4. An apparatus as set forth in claim 3 wherein each of said first passage and said second passage is of circular cross-section and said collection passage has a diameter no greater than the diameter of a respective one of said first passage and said second passage.

5. An apparatus as set forth in claim 1 wherein at least one of said first passage and said second passage has a constriction therein to constrict the flow of a respective compound therefrom.

6. An apparatus as set forth in claim 1 wherein mixing means includes at least one static mixing element for mixing of the first component and the second component into a reactive mixture.

7. An apparatus as set forth in claim 6 wherein said static mixing element comprises bars crossing each other, said bars being arranged at an angle of less than 90° in relation to a central axis of said collection passage.

8. An apparatus as set forth in claim 1 further comprising a heat exchanging means in said mixing block for heating of said collection passage.

9. An apparatus as set forth in claim 1 further comprising a fastening apparatus on said mixing block for securing a supply means for supplying a respective one of the one component and the second component in communication with a respective one of said first passage and said second passage.

10. An apparatus as set forth in claim 9 wherein said supply means includes an apertured mounting flange for abutting said mixing block and said fastening apparatus includes a pair of hoop elements secured to said mixing block and disposed on opposite sides of said flange for releaseably securing said flange between each respective hoop element and said mixing block.

11. An apparatus as set forth in claim 10 wherein said fastening means includes a plurality of screws for threadably securing each respective hoop element to said mixing block.

12. An apparatus as set forth in claim 10 wherein at least one of said hoop elements is pivotally mounted on said mixing block.

13. An apparatus as set forth in claim 1 further comprising a supply means for supplying a respective one of the one component and the second component in communication with a respective one of said first passage and said second passage, said supply means including a hose and an apertured flange at one end of said hose, said flange abutting said mixing block to communicate said hose with a respective one of said first passage and said second passage.

14. An apparatus as set forth in claim 13 further comprising a fastening apparatus on said mixing block for releaseably securing said flange to said mixing block in fluid-tight manner.

15. An apparatus as set forth in claim 14 wherein said fastening apparatus includes a pair of hoop elements secured to said mixing block and disposed on opposite sides of said flange for releaseably securing said flange between each respective hoop element and said mixing block.
